(19) United States
(12) Patent Application Publication
(10) Pub. No.: US 2023/0292106 A1
(43) Pub. Date: Sep. 14, 2023

(54) DEVICE INFORMATION PROCESSING SYSTEM, DEVICE INFORMATION PROCESSING APPARATUS, AND DEVICE INFORMATION PROCESSING METHOD

(71) Applicant: BUFFALO INC., Nagoya-shi (JP)

(72) Inventor: Akihiro ITO, Nagoya-shi (JP)

(73) Assignee: BUFFALO INC., Nagoya-shi (JP)

(21) Appl. No.: 18/179,389

(22) Filed: Mar. 7, 2023

(30) Foreign Application Priority Data
Mar. 10, 2022 (JP) 2022-037290

(51) Int. Cl. H04W 8/22; H04W 8/00

(52) U.S. Cl. CPC H04W 8/22; H04W 8/005

(57) ABSTRACT

A device information processing system includes a server and a device information processing apparatus, and the server acquires device identification information including an individual identification code unique to a device, and class identification information identifying a class identification code unique to a device class, and the device information processing apparatus receives the device identification information from the server, acquires the device identification information that fulfills a condition, extracts the class identification information from the device identification information, acquires a class identification code that is identified by the class identification information, and acquires configuration entries of a device corresponding to the class identification code.

### CROSS-REFERENCE TO RELATED APPLICATION

This application is based on and claims priority under 35 USC § 119 from Japanese Patent Application No. 2022-037290, filed on Mar. 10, 2022, the entire contents of which are incorporated herein by reference.

### TECHNICAL FIELD

The present disclosure relates to a device information processing system, a device information processing apparatus, and a device information processing method.

### BACKGROUND

In recent years, information processing apparatus has been widely used.

It takes time and trouble to set up a device when installed. If a large number of devices have to be installed in a lump, it takes an enormous amount of time and trouble.

An object of the present disclosure is to provide a device information processing system, a device information processing apparatus, and a device information processing method that can save time and trouble to install devices.

### SUMMARY

A device information processing system according to an aspect of the present disclosure includes a server; and device information processing apparatus, wherein the server includes processing circuitry configured to acquire a plurality of pieces of device identification information, the device identification information including (1) an individual identification code, which is unique to a device, and (2) a piece of class identification information, which identifies a class identification code, which is unique to a device class, and transmit the plurality of pieces of the device identification information to the device information processing apparatus, and the device information processing apparatus includes processing circuitry configured to receive the plurality of pieces of the device identification information from the server, acquire, from among the plurality of pieces of the device identification information received from the server, a first piece of the device identification information that fulfills a condition, extract a first piece of the class identification information from the first piece of the device identification information, acquire a first class identification code that is identified by the first piece of the class identification information, and acquire one or more configuration entries of a device corresponding to the first class identification code using the acquired first classification identification code.

### BRIEF DESCRIPTION OF DRAWINGS

Exemplary embodiments of the present disclosure will be described in detail based on the following figures, wherein:

FIG. 1 is a block diagram showing a configuration example of a device information processing system according to an embodiment of the present disclosure;

FIGS. 2A to 2D show content examples of a database included in the device information processing system;

FIG. 3 is a functional block diagram showing a configuration example of device information processing apparatus according to an embodiment of the present disclosure;

FIG. 4 is a flow chart showing an operation example of the device information processing apparatus;

FIG. 5 shows a window example provided by the device information processing apparatus; and

FIG. 6 shows a content example of another database.

### DETAILED DESCRIPTION OF THE DRAWINGS

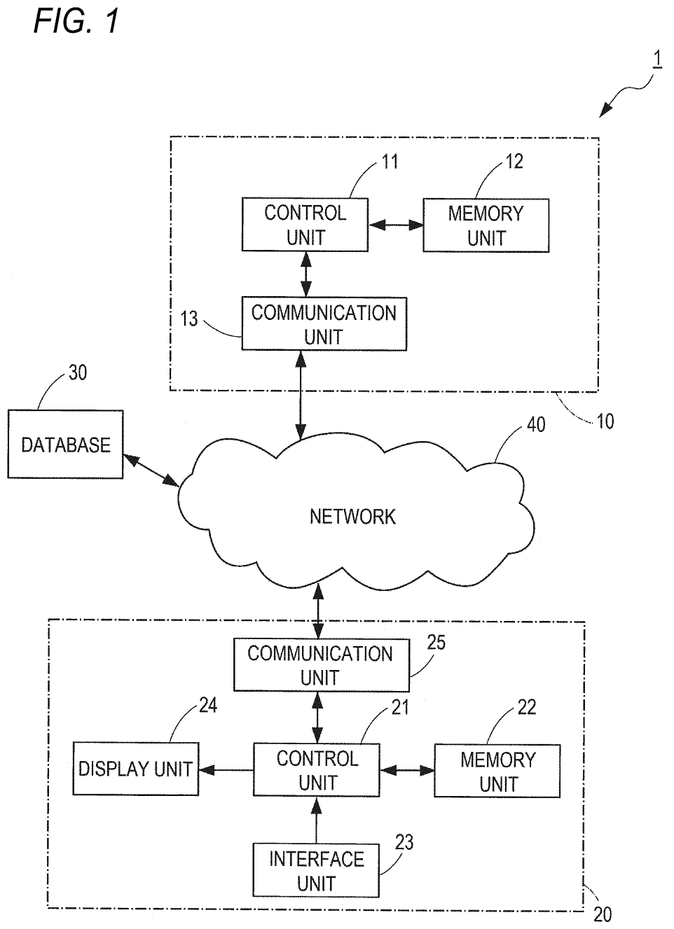

An embodiment of the present disclosure will be described with reference to the drawings. As exemplarily shown in FIG. 1, a device information processing system 1 according to the present embodiment includes a server 10, device information processing apparatus 20, and a database 30, which are connected to each other by a communication means, such as a network 40. The server 10 includes, for example, a control unit 11, a memory unit 12, and a communication unit 13. The device information processing apparatus 20 includes, for example, a control unit 21, a memory unit 22, an interface unit 23, a display unit 24, and a communication unit 25. The database 30 may be included in the server 10 or another server.

The control unit 11 of the server 10 is, for example, a central processing unit and is configured to operate in accordance with programs stored in the memory unit 12. For example, the control unit 11 is configured to acquire device identification information, each piece of which includes an individual identification code and a piece of class identification information. Individual identification codes are codes uniquely assigned to each device. Class identification information is information for identifying class identification codes, which are codes uniquely assigned to each device class. Operation of the control unit 11 will be described later in detail.

A piece of device identification information is, for example, a device-specific serial number including an individual identification code and a piece of class identification information. A piece of class identification information may be extracted from a serial number by the control unit 11 or 21, for example, if it is predetermined which part of the serial number corresponds to class identification information (or an individual identification code) or if some strings are reserved for class identification information (or individual identification codes). An individual identification code and a piece of class identification information are, for example, the whole and last four characters of a serial number respectively. An individual identification code may be only some characters of a serial number.

Class identification information of a device is, for example, the model number or the Global Trade Item Number (GTIN) of the device but are not limited thereto as long as a class identification code for the device can be acquired using device identification information of the device. In addition, a piece of device identification information does not have to include a class identification code. Apiece of class identification information may be acquired from a database storing relation between a piece of device identification information (or an individual identification code) and a piece of class identification information.

The memory unit 12 is, for example, a memory and/or a storage and is configured to store programs executable by the control unit 11. The programs may be loaded onto the memory unit 12 from a non-transitory computer-readable medium or a network. The memory unit 12 is also configured to function as a workspace or cache for the control unit 11.

The communication unit 13 is, for example, a network interface and is configured to transmit information to the device information processing apparatus 20, which is connected to the server 10 on the network 40, or other information processing apparatus in accordance with instructions that have been received from the control unit 11. The communication unit 13 is also configured to output, to the control unit 11, information that has been received from the device information processing apparatus 20 or other information processing apparatus.

The control unit 21 of the device information processing apparatus 20 is, for example, a central processing unit and is configured to operate in accordance with programs stored in the memory unit 22. The control unit 11 and/or the control unit 21 may be circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor. For example, the control unit 21 serving as a class acquisition unit 212 is configured to acquire device identification information that fulfills a condition to be described later, to extract class identification information from the device identification information, and to acquire a class identification code that is identified by each piece of the class identification information. Operation of the control unit 21 will be described later in detail.

The memory unit 22 is, for example, a memory and/or a storage and is configured to store programs executable by the control unit 21. The programs may be loaded onto the memory unit 22 from a non-transitory computer-readable medium or a network. The memory unit 22 is also configured to function as a workspace or cache for the control unit 21.

The interface unit 23 is, for example, a keyboard, a mouse, and/or a touch panel and is configured to receive user's operation and to output the user's instructions to the control unit 21. The display unit 24 is, for example, a display and is configured to display information in accordance with instructions that have been received from the control unit 21.

The communication unit 25 is, for example, a network interface and is configured to transmit information to the server 10, which is connected to the device information processing apparatus 20 on the network 40, or other information processing apparatus in accordance with instructions that have been received from the control unit 21. The communication unit 25 is also configured to output, to the control unit 21, information that has been received from the server 10 or other information processing apparatus.

The database 30 includes at least a model number database 30a, a class database 30b, a functionality database 30c, a configuration entry database 30d.

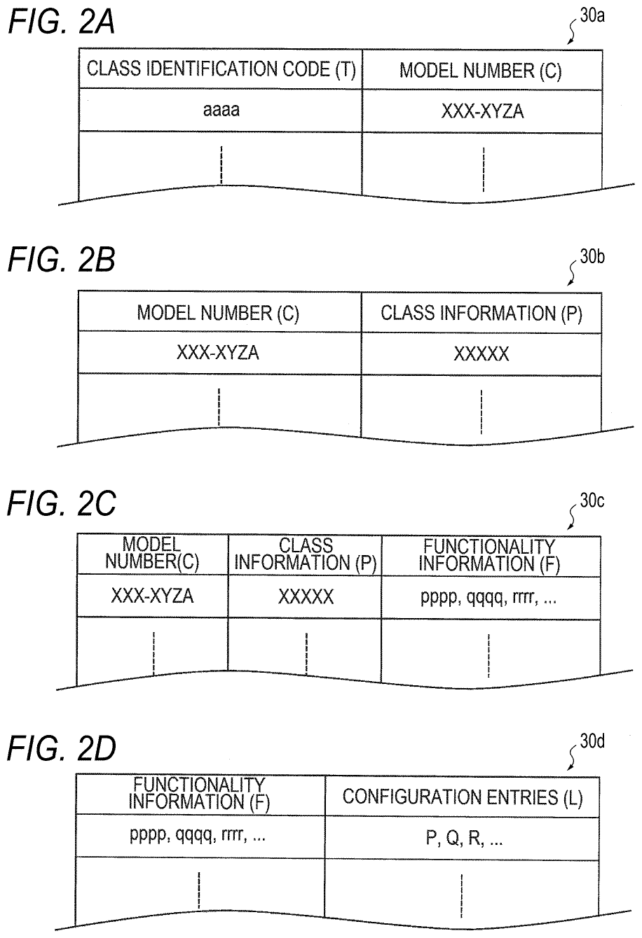

As exemplarily shown in FIG. 2A, the model number database 30a is configured to store relation between a class identification code (T), which is included in each piece of device identification information (I), and a model number (C), which is assigned, for example, by the manufacturer of a device.

As exemplarily shown in FIG. 2B, the class database 30b is configured to store relation between a model number (C) and a piece of class information (P), which identifies a device class.

As exemplarily shown in FIG. 2C, the functionality database 30c is configured to store relation between a pair of a model number (C) and a piece of class information (P) and a piece of functionality information (F), which describes functionality of a device. A piece of functionality information (F) lists functionality of a device identified by a pair of a model number (C) and a piece of class information(P). If the device is a wireless access point, for example, a facility for setting a service set identifier (SSID) or a facility for authentication may be included in the functionality information (F).

As exemplarily shown in FIG. 2D, the configuration entry database 30d is configured to store relation between a piece of functionality information (F) and configuration entries (L). If the device is a wireless access point, for example, the configuration entries (L) for the facility for setting an SSID may include “SSID,” and the configuration entries (L) for the facility for authentication may include “authentication method” and “password.”

The server 10 is provided to, for example, a manufacturer or a dealer that ships devices. When devices are shipped to a user, relation between a piece of user identification information that identifies the user and a piece of device identification information that identifies each of the devices are stored, for example, in the memory unit 12 of the server 10.

Next, operation of the control unit 11 of the server 10 will be described. For example, in response to a user of the device information processing apparatus 20 accessing the server 10, the control unit 11 authenticates the user and acquires a piece of user identification information of the user. The control unit 11 may authenticates the user, for example, using a username and a password. In response to a request from the authenticated user, the control unit 11 acquires pieces of device identification information that correspond to the authenticated user. Each piece of the device identification information includes, as described above, an individual identification code and a piece of class identification information of one of the shipped devices. The control unit 11 then transmits the acquired device identification information to the device information processing apparatus 20, which is the source of the request.

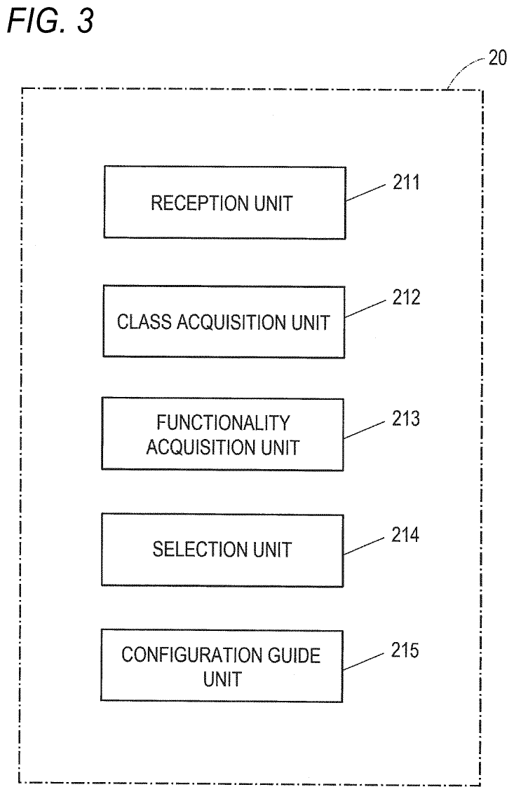

As exemplarily shown in FIG. 3, the control unit 21 of the device information processing apparatus 20 functionally includes a reception unit 211, the class acquisition unit 212, a functionality acquisition unit 213, a selection unit 214, a configuration guide unit 215.

In response to user's instructions to begin configurations of devices, the reception unit 211 instructs the class acquisition unit 212 to acquire class information. The class acquisition unit 212 requests the server 10 to transmit, to the device information processing apparatus 20, device identification information that corresponds to the user (that is, that fulfills a condition). The class acquisition unit 212 receives the device identification information that the server 10 has transmitted in response to the request from the device information processing apparatus 20.

The functionality acquisition unit 213 extracts a piece of class identification information from each piece of the device identification information that has been received by the class acquisition unit 212 and acquires class identification codes that are identified by the extracted class identification information.

Specifically, if the class identification information is GTIN, the functionality acquisition unit 213 extracts Item Reference, which serves as a class identification code, from GTIN.

The functionality acquisition unit 213 is used to determine configuration entries of each device that corresponds to the acquired class identification code. Specifically, the functionality acquisition unit 213 acquires information related to functionality of the device that corresponds to the extracted Item Reference, which is a class identification code.

The functionality acquisition unit 213 acquires the model number of the device that corresponds to the extracted class identification code, for example, from the model number database 30a of the database 30. The functionality acquisition unit 213 further acquires a piece of class information that corresponds to the acquired model number, for example, from the class database 30b of the database 30. The functionality acquisition unit 213 further acquires a piece of functionality information that corresponds to a pair of the acquired model number and the acquired class information, for example, from the functionality database 30c of the database 30.

The functionality acquisition unit 213 acquires configuration entries that correspond to the acquired functionality information, for example, from the configuration entry database 30d of the database 30.

In this manner, the functionality acquisition unit 213 acquires a model number, a piece of class information, a piece of functionality information, and configuration entries, based on each piece of device identification information that has been acquired by the class acquisition unit 212.

The selection unit 214 provides the user with a list of the device identification information that the class acquisition unit 212 has acquired from the server 10, the model numbers, the class information, and/or other information. The user selects, for example, a piece of device identification information from the list. The selection unit 214 may be omitted, for example, if the class acquisition unit 212 has received only one piece of device identification information from the server 10 or if some piece of device identification information are selected automatically without user's operation in accordance with some rules.

For a configuration guide, the configuration guide unit 215 provides the user with configuration entries that correspond to the device identification information that has been selected manually or automatically. The user sets up a shipped device by setting a value for each of the configuration entries.

Bulk Registration Feature

The device information processing system 1 according to the present embodiment has a feature of registering, in a lump, a large number of devices that have been received (introduced) from a manufacturer or a dealer also in a lump. For example, each time it ships devices in a lump, it issues a bulk registration number (an example of a bulk identification code) and stores relation between the bulk registration number and device identification information of the devices shipped in a lump in the memory unit 12 of the server 10 serving as a bulk registration number database.

It stores information, such as a class identification code, the model number, class identification information, and functionality information, of each of the devices in the model number database 30a, the class database 30b, the functionality database 30c, and the configuration entry database 30d of the database 30.

For example, in response to a user of the device information processing apparatus 20 accessing the server 10, the control unit 11 of the server 10 authenticates the user. In response to a request with a bulk registration number from the authenticated user, the control unit 11 acquires device identification information that correspond to the bulk registration number from the bulk registration number database. The control unit 11 then transmits the acquired device identification information to the device information processing apparatus 20, which is the source of the request.

On the other hand, the user of the device information processing apparatus 20 receives the bulk registration number in advance from the manufacture or the like that shipped the devices in a lump. In response to the user's instructions with the bulk registration number to begin configurations of devices, the reception unit 211 instructs the class acquisition unit 212 to acquire class information.

The class acquisition unit 212 requests the server 10 to transmit, to the device information processing apparatus 20, device identification information corresponding to the bulk registration number that has been received by the reception unit 211 (that is, that fulfills a condition). The class acquisition unit 212 receives the device identification information that the server 10 has transmitted in response to the request from the device information processing apparatus 20.

In this example, the functionality acquisition unit 213, the selection unit 214, the configuration guide unit 215 operate similarly to the example above.

Batch Configuration Feature

The configuration guide unit 215 may provide a user with configuration entries of devices identified by pieces of device identification information (hereinafter, referred to “target device identification information”) selected manually or automatically from those that has been acquired by the functionality acquisition unit 213 for configuration targets, based on functionality information that corresponds to class identification codes included in the target device identification information.

For example, if the target device identification information includes a class identification code a, whose configuration entries are p and q, and a class identification code b, whose configuration entries are p and r, the guide unit 215 may provide the user with a configuration guide window showing the disjunctive configuration entries p, q, and r or the conjunctive configuration entry p in order to prompt the user to input setting values. That is, by calculating disjunction or conjunction of configuration entries over the target device identification information, the guide unit 215 may provide the user with the configuration guide window showing all the configuration entries of each device or configuration entries common to all the devices.

When the user or the like finishes the configurations, the information processing apparatus 10 instructs a device identified by each piece of the target device identification information to accept setting values for configuration entries if any. The information processing apparatus 10 communicates with the device, based on the media access control (MAC) address of the device. In this manner, time and trouble to set common values into a plurality of devices is saved.

Operation

Next, an operation example of the device information processing system 1 of the present embodiment will be described. In the following example, a user receives a large number of network devices, such as wireless routers and network switches, from a manufacturer or a dealer in a lump.

When it ships the network devices, it issues a bulk registration number and stores relation between the bulk registration number and device identification information of the network devices in the memory unit 12 of the server 10 serving as a bulk registration number database. In this example, device identification information of each network device includes the serial number and the GTIN, which serves as class identification information, of the device. In addition, relation between device identification information of a network device and the MAC address of the network device may be stored in the bulk registration number database.

It stores information, such as a class identification code, the model number, class identification information, and functionality information, of each of the network devices in the model number database 30a, the class database 30b, the functionality database 30c, and the configuration entry database 30d in advance.

The user receives the network devices from the manufacture or the like that shipped the network devices in a lump with the bulk registration number, installs (turns on and connects to the network 40) the network devices, and instructs the device information processing apparatus 20 to begin configurations of the network devices with the bulk registration number in order to set up the network devices. The user may entrust a third party with installing the network devices.

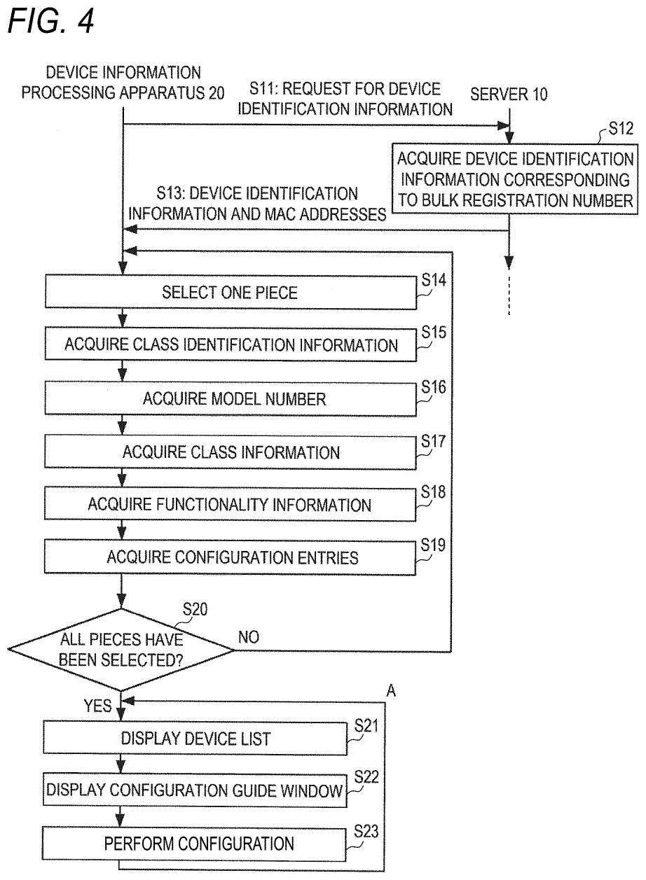

As shown in FIG. 4, in response to the user's instructions with the bulk registration number, the device information processing apparatus 20 requests the server 10 to transmit, to the device information processing apparatus 20, device identification information and the MAC addresses that correspond to the bulk registration number (S11).

The server 10 authenticates the user and respond to the request with the bulk registration number from the device information processing apparatus 20. That is, the server 10 acquires device identification information and MAC addresses that correspond to the acquired bulk registration number from the bulk registration number database (S12) and then transmits the acquired device identification information and the acquired MAC addresses to the device information processing apparatus 20, which is the source of the request (S13).

The device identification information includes a plurality of pieces since the user received a plurality of network devices in a lump with the bulk registration number.

The device information processing apparatus 20 receives the device identification information and the MAC addresses from the server 10 and selects one piece of the device identification information and one of the MAC addresses corresponding thereto (S14).

The device information processing apparatus 20 extracts class identification information from the device identification information selected in S14 and acquires a class identification code identified by the extracted device identification information (S15). Since class identification information is GTIN in this example, the device information processing apparatus 20 extracts Item Reference, which serves as a class identification code, from GTIN.

The device information processing apparatus 20 acquires the model number that corresponds to the extracted class identification code from the model number database 30a (S16), acquires a piece of class information that corresponds to the acquired model number from the class database 30b (S17), and acquires a piece of functionality information that corresponds to a pair of the acquired model number and the acquired class information from the functionality database 30c (S18).

The device information processing apparatus 20 acquires configuration entries that correspond to the functionality information that has been acquired in S18 from the configuration entry database 30d (S19).

The device information processing apparatus 20 repeats S14 to S19 until all the pieces of the device identification information have been selected in S14 (S20).

Next, the device information processing apparatus 20 provides the user with a list of the device identification information acquired in S13 and at least some of the information acquired in S15 to S19 (S21) and prompts the user to select some of the network devices for configuration targets.

The device information processing apparatus 20 calculates the disjunctive configuration entries for the configuration targets and displays a configuration guide window for the user to input setting values into the disjunctive configuration entries.

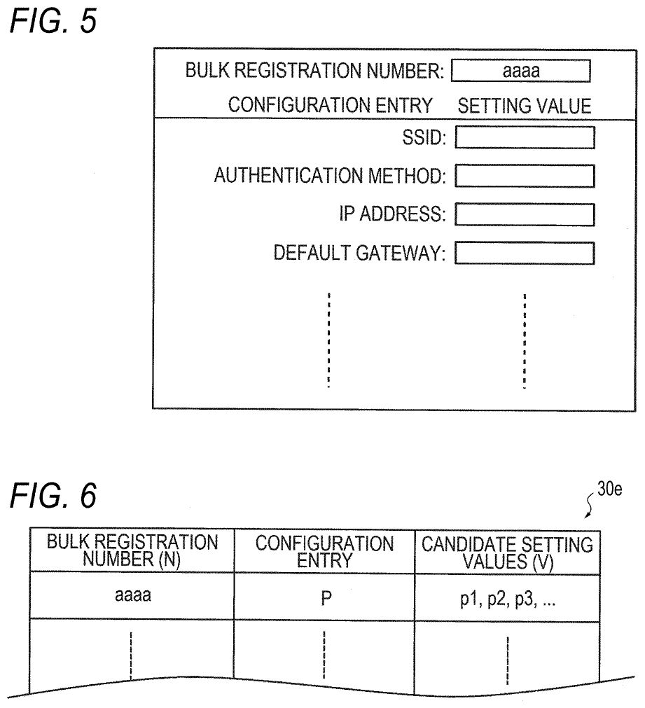

For example, if the user selects, for the configuration targets, a wireless router whose configuration entries are “SSID,” “authentication method,” and “IP address” and a network switch whose configuration entries are “IP address,” and “default gateway,” the device information processing apparatus 20 displays a configuration guide window for the user to input setting values into “SSID,” “authentication method,” “IP address,” and “default gateway,” which are the disjunctive configuration entries. The device information processing apparatus 20 receives the user's input of setting values (S22). FIG. 5 is an example of the configuration guide window displayed to the user in S22.

After the user has completed inputting the setting values, the device information processing apparatus 20 acquires the MAC addresses of the configuration targets that have been selected in S21 by the user and instructs network devices identified by each of the MAC addresses to accept the setting values to perform the configuration (S23).

As for configuration entries that are not included in the configuration entries of each of the configuration targets (for example, “default gateway” for the wireless router and “SSID” and “authentication method” for the network switch), the setting values thereof do not have to transmitted to the configuration target.

If the user proceeds to configurations of other network devices, the device information processing apparatus 20 repeats S21 to S23 (A).

According to the present embodiment, the user does not have to check the model of each device that the user received in a lump and can easily set up devices simply by following the list of configuration entries based on device identification information.

Another Example of Device List

When the device information processing apparatus 20 provides the user with the device list in S21 shown in FIG. 4 in the example above, the list may include an operation state or configuration state of each network device. In this case, the device information processing apparatus 20 acquires such states by communicating with each network device based on the MAC address corresponding to the device identification information in the device list.

In this case, each network device responds to the request from the device information processing apparatus 20 and informs the device information processing apparatus 20 whether there is an error in a setting or not (for example, unable to communicate with other devices since the IP address is undefined or incorrect) or whether the network device is being communicating with another device or not (an example of the operation state).

In addition, the server 10 may be configured to store, in the bulk registration number database, relation between a piece of class information and information input by a user or a third party that installs network devices. Examples of such information are the name of a network group to which a network device should belong and a memorandum.

The device information processing apparatus 20 acquires such information that is stored correspondingly to device identification information corresponding to an input bulk registration number from the server 10 and provides the user with the list including the information in S21 shown in FIG. 4.

In addition, the device information processing apparatus 20 may be configured to search the list for items that fulfills a condition using a variety of information, such as a model number and device identification information, acquired, for example, from the database 30. In this case, the device information processing apparatus 20 receives input of the condition from the user or the third party

The device information processing apparatus 20 may select device identification information included in the search result for configuration targets.

Candidate Setting Values in Configuration Guide Window

The database 30 may further includes a profile database 30e (FIG. 6) for user's convenience. The profile database 30e is configured to store relation between a bulk registration number (N) and pairs of configuration entries of a device that is identified by a piece of device identification information corresponding to, based on the bulk registration number database, the bulk registration number (N) and candidate setting values (V) for the configuration entries. The name of each configuration entry stored in the profile database 30e should match that of the corresponding configuration entry stored in the configuration entry database 30d.

The candidate setting values (V) are input by, for example, a third party that installs the devices. Each configuration entry may have one or more candidate setting values.

For example, the device information processing apparatus 20 may receive candidate setting values and may register them in the profile database 30e. In this case, the device information processing apparatus 20 receives a bulk registration number, for example, from a third party that installs the devices.

Through, for example, S11 to S19 shown in FIG. 4, the device information processing apparatus 20 acquires device identification information that corresponds to the bulk registration number, acquires class identification codes that correspond to the acquired device identification information, and acquire functionality information of the introduced devices from the database 30, based on the class identification codes. The device information processing apparatus 20 further acquires configuration entries corresponding to the functionality information.

The device information processing apparatus 20 provides the configuration entries that the introduced devices have with the third party or the like and receives one or more candidate setting values for one of the configuration entries.

In response to completion of the input, the device information processing apparatus 20 registers, in the profile database 30e, relation between a bulk registration number and pairs of configuration entries and candidate setting values for the configuration entries.

In S22 shown in FIG. 4, the device information processing apparatus 20 acquires pairs of configuration entries and candidate setting values that correspond to a bulk registration number from the profile database 30e of the database 30 and provide the candidate setting values along with the configuration entries in the configuration guide window.

For example, if a third party installs a plurality of wireless router that a user received with a bulk registration number from the manufacturer, the third party may register relation between the bulk registration number and a pair of the configuration entry “SSID” and a plurality of candidate setting values for “SSID.” Each of the candidate setting values for “SSID” may correspond to, for example, a floor that a wireless router is to be installed on. When a wireless router has been installed on a floor, the third party notes down relation between the serial number of the wireless router and the floor.

Afterward, the user or the third party causes the device information processing apparatus 20 to execute processing, for example, shown in FIG. 4. During the processing, the device information processing apparatus 20 acquires configuration entries and candidate setting values that correspond to the input bulk registration number from the profile database 30e and presents them in the configuration guide window.

In the example above, the user or the third party that uses the device information processing apparatus 20 selects, from the device list provided in S21 shown in FIG. 4, pieces of device identification information that include serial numbers of the wireless routers that were noted down along with the floors when the third party installed them.

The device information processing apparatus 20 shows configuration entries that correspond to the selected device identification information along with candidate setting values if acquired from the profile database 30e.

In this case, the device information processing apparatus 20 enables easy setup of devices by presenting candidate setting values in the configuration guide window if they are predefined.

A bulk registration number may be unconnected with setting values or candidate setting values. Specifically, if first devices, which are identified by a first bulk registration number, and second devices, which are identified by a second bulk registration number, are registered, devices that have a common model number or similar configuration entries may be set up in a lump. Further, devices may be set up in a lump using a list in which the bulk registration number and the device identification information directly input by the third party in advance are combined with each other.

Although an individual identification code and a class identification code are included in a single piece of device identification information in the above embodiment, the present disclosure is not limited thereto. An individual identification code may be, for example, a device-specific serial number, and class identification information may be a QR code (registered trademark) including, for example, GTIN or Universal Product Code.

According to an aspect of the present disclosure, class identification codes, which determine configuration entries, are acquired based on device identification information of devices. Therefore, it becomes possible to save time and trouble to install the devices.

The processing circuitry of the server may be configured to store, in a memory, relation between: a bulk identification code, which identifies a plurality of devices that is introduced in a lump, and; a plurality of pieces of the device identification information. The processing circuitry of the device information processing apparatus may be configured to receive a bulk identification code. The condition may be that the piece of the device identification information corresponds to the received bulk identification code.

By acquiring class identification codes or other information based on a bulk identification code, it becomes possible to save time and trouble to install the devices.

Device information processing apparatus according to another aspect of the present disclosure includes processing circuitry. The processing circuitry is configured to: access a first database, which stores relation between: a bulk identification code, which identifies a plurality of devices that is introduced in a lump; and a piece of device identification information, which includes: an individual identification code, which is unique to each of the introduced devices; and a piece of class identification information, which identifies a class identification code, which is unique to a device class; receive a bulk identification code; acquire a plurality of the device identification information that corresponds to the received bulk identification code from the first database; extract a piece of the class identification information from each of at least one piece of the acquired device identification information; and acquire a class identification code that is identified by each piece of the class identification information. Each of the acquired class identification codes is used to determine one or more configuration entries of a device corresponding to the each of the acquired class identification codes.

According to this aspect of the present disclosure, by acquiring class identification codes or other information based on a bulk identification code, it becomes possible to save time and trouble to install the devices.

The at least one piece of the acquired device identification information may be selected from the plurality of the acquired device identification information by a user. The processing circuitry may be further configured to: acquire a piece of functionality information of a device that corresponds to each of the acquired class identification codes from a second database, which stores relation between a class identification code and a piece of the functionality information of a device whose class is identified by the class identification code;

and output data of a window showing at least one configuration entry of a device that corresponds to one of the at least one piece of the acquired device identification information, based on the acquired functionality information.

By displaying configuration entries, it becomes possible to save time and trouble to install the devices.

The processing circuitry may be further configured to output data of a window showing all the configuration entries of each device that corresponds to the at least one piece of the acquired device identification information, based on the acquired functionality information.

As another configuration, the processing circuitry may be further configured to output data of a window showing configuration entries common to all the devices that correspond to the at least one piece of the acquired device identification information, based on the acquired functionality information.

The window may further show a candidate setting value for each of the at least one configuration entry if the candidate setting value is predefined

The processing circuitry may be further configured to: acquire a piece of functionality information of a device that corresponds to each of the acquired class identification codes from a second database, which stores relation between a class identification code and a piece of the functionality information of a device whose class is identified by the class identification code; receive a setting value for one or more configuration entries corresponding to at least one piece of the acquired functionality information; and store, in a memory, relation between the acquired setting value for the one or more configuration entries and the received bulk identification code.

According to these configurations, it becomes possible to save time and trouble to install the devices.

A server according to another aspect of the present disclosure includes processing circuitry. The processing circuitry is configured to: acquire a piece of class identification information that is acquired from a piece of device identification information, which includes: an individual identification code, which is unique to a device; and a piece of the class identification information, which identifies a class identification code, which is unique to a device class; and provide a piece of class information and/or functionality information of a device, based on the piece of the acquired class identification information.

A device information processing method according to another aspect of the present disclosure includes: receiving a bulk identification code, which identifies a plurality of devices that is introduced in a lump; acquiring a plurality of device identification information that corresponds to the received bulk identification code from a first database, which stores relation between: a bulk identification code; and a piece of the device identification information, which includes: an individual identification code, which is unique to each of the introduced devices; and a piece of class identification information, which identifies a class identification code, which is unique to a device class; extracting a piece of the class identification information from each of at least one piece of the acquired device identification information; and acquiring a class identification code that is identified by each piece of the class identification information. Each of the acquired class identification codes is used to determine one or more configuration entries of a device corresponding to the each of the acquired class identification codes.

According to the present disclosure, it becomes possible to save time and trouble to install devices.

1. A device information processing system, comprising:
a server; and
a device information processing apparatus, wherein
the server includes processing circuitry configured to
acquire a plurality of pieces of device identification information, the device identification information including (1) an individual identification code, which is unique to a device, and (2) a piece of class identification information, which identifies a class identification code, which is unique to a device class, and
transmit the plurality of pieces of the device identification information to the device information processing apparatus, and
the device information processing apparatus includes processing circuitry configured to
receive the plurality of pieces of the device identification information from the server,
acquire, from among the plurality of pieces of the device identification information received from the server, a first piece of the device identification information that fulfills a condition,
extract a first piece of the class identification information from the first piece of the device identification information,
acquire a first class identification code that is identified by the first piece of the class identification information, and
acquire one or more configuration entries of a device corresponding to the first class identification code using the acquired first classification identification code.

2. The device information processing system according to claim 1, wherein
the processing circuitry of the server is further configured to store, in a memory, relation between:
a bulk identification code, which identifies a plurality of devices that is introduced in a lump, and
another plurality of pieces of the device identification information,
the processing circuitry of the device information processing apparatus is configured to receive a first bulk identification code, and
the condition is that the first piece of the device identification information corresponds to the first bulk identification code.

3. A device information processing apparatus comprising:
processing circuitry configured to
access a first database, which stores relation between (1) a bulk identification code, which identifies a plurality of devices that is introduced in a lump, and (2) a plurality of pieces of device identification information, each of which includes (a) an individual identification code, which is unique to each of the introduced devices, and (b) a piece of class identification information, which identifies a class identification code, which is unique to a device class;
receive a first bulk identification code;
acquire, from among the plurality of pieces of the device identification information in the first database, a first piece of the device identification information that corresponds to the first bulk identification code;
extract a first piece of the class identification information from the first piece of the device identification information;
acquire a first class identification code that is identified by the first piece of the class identification information; and
acquire one or more configuration entries of a device corresponding to the first class identification codes using the acquired first class identification code.

4. The device information processing apparatus according to claim 3, wherein
the first piece of the device identification information is selected from the plurality of pieces of the device identification information by a user, and
the processing circuitry is further configured to:
acquire a piece of functionality information of the device from a second database, which stores relation between the first class identification code and the piece of the functionality information of the device; and
output data of a window showing at least one of the one or more configuration entries of the device based on the acquired piece of the functionality information.

5. The device information processing apparatus according to claim 4, wherein
the processing circuitry is further configured to output data of a window showing all the configuration entries of the one or more configuration entries, based on the acquired piece of the functionality information.

6. The device information processing apparatus according to claim 4, wherein
the processing circuitry is further configured to output data of a window showing configuration entries common to all the devices, each of which corresponds to each piece of the device identification information, based on the acquired piece of the functionality information.

7. The device information processing apparatus according to claim 4, wherein
the window further shows a candidate setting value for each of the one or more configuration entries in response to the candidate setting value being predefined.

8. The device information processing apparatus according to claim 3, wherein
the processing circuitry is further configured to:
acquire a piece of functionality information of the device from a second database, which stores relation between the first class identification code and the piece of the functionality information of the device;
receive a setting value for the one or more configuration entries corresponding to the acquired piece of the functionality information; and
store, in a memory, relation between the acquired setting value for the one or more configuration entries and the first bulk identification code.

9. A device information processing method comprising:
accessing a first database, which stores relation between (1) a bulk identification code, which identifies a plurality of devices that is introduced in a lump, and (2) a plurality of pieces of device identification information, each of which includes (a) an individual identification code, which is unique to each of the introduced devices, and (b) a piece of class identification information, which identifies a class identification code, which is unique to a device class;
receiving a first bulk identification code;
acquiring, using processing circuitry, from among the plurality of pieces of the device identification information in the first database, a first piece of the device identification information that corresponds to the first bulk identification code;
extracting, using the processing circuitry, a first piece of the class identification information from the first piece of the device identification information;
acquiring, using the processing circuitry, a first class identification code that is identified by the first piece of the class identification information; and
acquiring, using the processing circuitry, one or more configuration entries of a device corresponding to the first class identification codes using the acquired first class identification code.

10. A non-transitory computer-readable medium having recorded thereon a program that causes a computer to execute the device information processing method according to claim 9.
